(19) United States
(12) Patent Application Publication
(10) Pub. No.: US 2008/0100816 A1
(43) Pub. Date: May 1, 2008

(54) Lithographic apparatus and method

(75) Inventors: Heine Melle Mulder, Veldhoven (NL); Wilfred Edward Endendijk, Steensel (NL); Edwin Eduard Nicolaas Josephus Krijnen, Geffen (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 11/589,990

(22) Filed: Oct. 31, 2006

(51) Int. Cl. G03B 27/80

(52) U.S. Cl. 355/68; 355/69

(57) ABSTRACT

An illuminator for a lithographic apparatus is disclosed, the illuminator including an array of individually controllable reflective elements capable of changing the angular intensity distribution of an incident illumination beam of radiation, wherein the array of individually controllable reflective elements is provided on a curved support structure, or the array of individually controllable reflective elements is arranged to serve as a curved reflective surface.

### FIELD

The present invention relates to a lithographic apparatus and method.

### BACKGROUND

A lithographic apparatus is a machine that applies a desired pattern onto a target portion of a substrate. Lithographic apparatus can be used, for example, in the manufacture of integrated circuits (ICs). In that circumstance, a patterning device, which is alternatively referred to as a mask or a reticle, may be used to generate a circuit pattern corresponding to an individual layer of the IC, and this pattern can be imaged onto a target portion (e.g. comprising part of, one or several dies) on a substrate (e.g. a silicon wafer) that has a layer of radiation-sensitive material (resist).

Instead of a mask, the patterning device may comprise a patterning array that comprises an array of individually controllable elements. An advantage of such a system compared to a mask-based system is that the pattern can be changed more quickly and for less cost.

In general, a single substrate will contain a network of adjacent target portions that are successively exposed. Known lithographic apparatus include so-called steppers, in which each target portion is irradiated by exposing an entire pattern onto the target portion in one go, and so-called scanners, in which each target portion is irradiated by scanning the pattern through the beam in a given direction (the “scanning”-direction) while synchronously scanning the substrate parallel or anti-parallel to this direction.

A lithographic apparatus typically comprises an illuminator to provide a conditioned illumination beam of radiation. In some circumstances it may be desirable to change the angular intensity distribution of a propagating illumination beam, in order to control the spatial intensity distribution in the cross section of the illumination beam. In order to change the angular intensity distribution of the illumination beam it is known to provide one or more diffractive optical elements within the illuminator. The diffractive optical element causes different parts of the illumination beam to be diffracted at different angles, and thus changes the shape of what is known as the pupil plane of the illumination beam. Alternatively, it is known to provide an array of individually controllable elements, such as a programmable mirror array, arranged to selectively redirect portions of the illumination beam to control the angular intensity distribution of the illumination beam. Since an array of individually controllable elements are used, the angular distribution of the illumination beam can be readily changed from one angular distribution to another. However, an illuminator which uses an array of individually controllable elements to control the angular intensity distribution of the illumination beam may have a larger footprint than an illuminator that does not use an array of individually controllable elements. Space in and around a lithographic apparatus may be valuable, and an illuminator with a larger footprint reduces the amount of available space.

### SUMMARY

According to an aspect of the invention, there is provided an illuminator for a lithographic apparatus, the illuminator comprising:

an array of individually controllable reflective elements capable of changing the angular intensity distribution of an incident illumination beam of radiation,

wherein the array of individually controllable reflective elements is provided on a curved support structure, or the array of individually controllable reflective elements is arranged to serve as a curved reflective surface.

According to an aspect of the invention, there is provided a method of conditioning an illumination beam of radiation using an illuminator, the method comprising:

illuminating an array of individually controllable reflective elements with the illumination beam of radiation, the array of individually controllable reflective elements being capable of changing the angular intensity distribution of the illumination beam of radiation; and

controlling the position or orientation of the reflective elements by providing the array of individually controllable reflective elements with an input signal to cause the array to serve as a curved reflective surface.

According to an aspect of the invention, there is provided a method of correcting for imperfections in an optical apparatus used in an illuminator, the illuminator comprising an array of individually controllable reflective elements capable of changing the angular intensity distribution of an incident illumination beam of radiation, the array of individually controllable reflective elements being provided on a curved support structure, or the array of individually controllable reflective elements being arranged to serve as a curved reflective surface, the method comprising:

illuminating the array of individually controllable reflective elements with the illumination beam of radiation; and

controlling the position or orientation of the reflective elements to correct for imperfections in the optical apparatus used in the illuminator.

According to an aspect of the invention, there is provided a lithographic apparatus, comprising:

an illuminator configured to condition a beam of radiation, the illuminator comprising an array of individually controllable reflective elements capable of changing the angular intensity distribution of an incident illumination beam of radiation, the array of individually controllable reflective elements being provided on a curved support structure, or the array of individually controllable reflective elements being arranged to serve as a curved reflective surface;

a support structure configured to hold a patterning device, the patterning device configured to impart the beam with a pattern in its cross-section;

a substrate table configured to hold a substrate; and

a projection system configured to project the patterned beam onto a target portion of the substrate.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts a part of a proposed illuminator;

FIGS. 3a and 3b depict an array of individually controllable reflective elements as employed in an embodiment of the invention;

FIG. 4 depicts part of an illuminator according to an embodiment of the invention; and

FIG. 5 illustrates a comparison between the footprints of the illuminator parts of FIGS. 2 and 4.

### DETAILED DESCRIPTION

Although specific reference may be made in this text to the use of lithographic apparatus in the manufacture of ICs, it should be understood that the illumination apparatus and lithographic apparatus described herein may have other applications, such as the manufacture of integrated optical systems, guidance and detection patterns for magnetic domain memories, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist) or a metrology or inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of 365, 248, 193, 157 or 126 nm) and extreme ultra-violet (EUV) radiation (e.g. having a wavelength in the range of 5-20 nm), as well as particle beams, such as ion beams or electron beams.

The term “patterning device” used herein should be broadly interpreted as referring to any device that can be used to impart a beam with a pattern in its cross-section such as to create a pattern in a target portion of the substrate. It should be noted that the pattern imparted to the beam may not exactly correspond to the desired pattern in the target portion of the substrate. Generally, the pattern imparted to the beam will correspond to a particular functional layer in a device being created in the target portion, such as an integrated circuit.

A patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions; in this manner, the reflected beam is patterned.

The support structure holds the patterning device in a way depending on the orientation of the patterning device, the design of the lithographic apparatus, and other conditions, such as for example whether or not the patterning device is held in a vacuum environment. The support structure may use mechanical clamping, vacuum, or other clamping techniques, for example electrostatic clamping under vacuum conditions. The support structure may be a frame or a table, for example, which may be fixed or movable as required and which may ensure that the patterning device is at a desired position, for example with respect to the projection system. Any use of the terms “reticle” or “mask” herein may be considered synonymous with the more general term “patterning device”.

The term “projection system” used herein should be broadly interpreted as encompassing various types of projection system, including refractive optical systems, reflective optical systems, and catadioptric optical systems, as appropriate for example for the exposure radiation being used, or for other factors such as the use of an immersion fluid or the use of a vacuum. Any use of the term “projection lens” herein may be considered as synonymous with the more general term “projection system”.

The illumination system may also encompass various types of optical components, including refractive, reflective, and catadioptric optical components for directing, shaping, or controlling the beam of radiation, and such components may also be referred to below, collectively or singularly, as a “lens”.

The lithographic apparatus may be of a type having two (dual stage) or more substrate tables (and/or two or more support structures). In such “multiple stage” machines the additional tables (and/or support structures) may be used in parallel, or preparatory steps may be carried out on one or more tables (and/or support structures) while one or more other tables (and/or support structures) are being used for exposure.

The lithographic apparatus may also be of a type wherein the substrate is immersed in a liquid having a relatively high refractive index, e.g. water, so as to fill a space between the final element of the projection system and the substrate. Immersion liquids may also be applied to other spaces in the lithographic apparatus, for example, between the mask and the first element of the projection system. Immersion techniques are well known in the art for increasing the numerical aperture of a projection system.

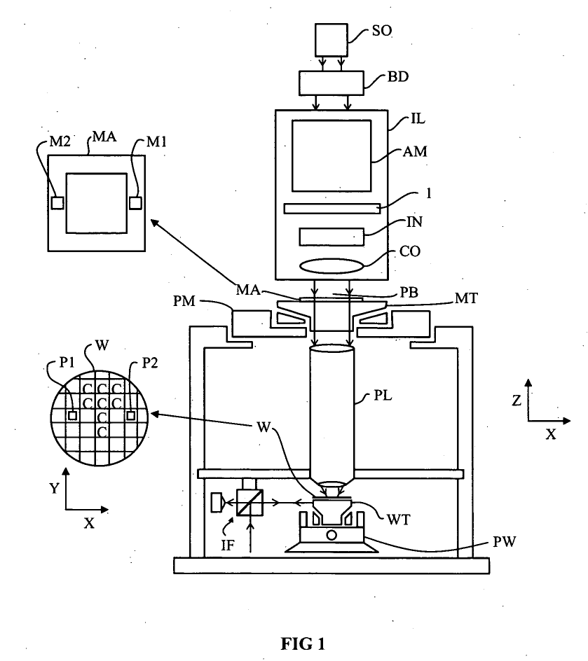

FIG. 1 schematically depicts a lithographic apparatus incorporating an illuminator according to a particular embodiment of the invention. The lithographic apparatus comprises:

an illumination system (illuminator) IL configured to condition a beam PB of radiation (e.g. UV radiation);

a support structure (e.g. a mask table) MT configured to hold a patterning device (e.g. a mask) MA and connected to a first positioning device PM to accurately position the patterning device with respect to item PL;

a substrate table (e.g. a wafer table) WT configured to hold a substrate (e.g. a resist-coated wafer) W and connected to a second positioning device PW to accurately position the substrate with respect to item PL; and

a projection system (e.g. a refractive projection lens) PL configured to image a pattern imparted to the beam PB by the patterning device MA onto a target portion C (e.g. comprising one or more dies) of the substrate W.

As here depicted, the apparatus is of a transmissive type (e.g. employing a transmissive mask). Alternatively, the apparatus may be of a reflective type (e.g. employing a programmable mirror array of a type as referred to above).

The illuminator IL receives a beam of radiation from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be integral part of the apparatus, for example when the source is a mercury lamp. The source SO and the illuminator IL, together with the beam delivery system BD if required, may be referred to as a radiation system.

The illuminator IL may comprise an adjusting device AM configured to adjust the angular intensity distribution of the beam. Generally, at least the outer and/or inner radial extent (commonly referred to as σ-outer and σ-inner, respectively) of the intensity distribution in a pupil plane of the illuminator can be adjusted. In addition, the illuminator IL generally comprises various other components, such as an integrator IN and a condenser CO. The illuminator provides a conditioned beam of radiation PB having a desired uniformity and intensity distribution in its cross-section.

In accordance with an embodiment, the illuminator IL further comprises a programmable mirror array 1 arranged to modulate the beam PB, as will be described in more detail below. FIG. 1 schematically illustrates the illuminator IL, and it will be appreciated that the adjusting device AM, programmable mirror array 1 (or another suitable array of individually controllable elements), integrator IN and condenser CO may be positioned or oriented in any suitable manner to provide the beam PB. It can be seen that, in functional terms, a radiation beam from the source SO enters the illuminator IL, where it is conditioned to emerge from the illuminator IL as the beam PB. It will be appreciated that the beam PB may exit the illuminator IL along a beam path transverse to the beam path of the beam from the source SO.

The beam PB is incident on the patterning device MA, which is held on the support structure MT. Having traversed the patterning device MA, the beam PB passes through the projection system PL, which focuses the beam onto a target portion C of the substrate W. With the aid of the second positioning device PW and position sensor IF (e.g. an interferometric device), the substrate table WT can be moved accurately, e.g. so as to position different target portions C in the path of the beam PB. Similarly, the first positioning device PM and another position sensor (which is not explicitly depicted in FIG. 1) can be used to accurately position the patterning device MA with respect to the path of the beam PB, e.g. after mechanical retrieval from a mask library, or during a scan. In general, movement of the object tables MT and WT will be realized with the aid of a long-stroke module (coarse positioning) and a short-stroke module (fine positioning), which form part of the positioning devices PM and PW. However, in the case of a stepper (as opposed to a scanner) the support structure MT may be connected to a short stroke actuator only, or may be fixed. Patterning device MA and substrate W may be aligned using patterning device alignment marks M1, M2 and substrate alignment marks P1, P2.

The depicted apparatus can be used in one or more of the following modes:

1. In step mode, the support structure MT and the substrate table WT are kept essentially stationary, while an entire pattern imparted to the beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the beam is projected onto a target portion C (i.e. a single dynamic exposure). The velocity and direction of the substrate table WT relative to the support structure MT is determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure MT is kept essentially stationary holding a programmable patterning device, and the substrate table WT is moved or scanned while a pattern imparted to the beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes a programmable patterning device, such as a programmable mirror array of a type as referred to above.

Combinations and/or variations on the above described modes of use or entirely different modes of use may also be employed.

In place of a mask table MT and a mask MA, there may be provided a patterning device PD (e.g. an array of individually controllable elements) that modulates the beam PB. Generally, the pattern created on the target portion of the substrate will correspond to a particular functional layer in a device being created in the target portion, such as an integrated circuit or a flat panel display (e.g., a color filter layer in a flat panel display or a thin film transistor layer in a flat panel display). Examples of such a patterning device include, e.g., programmable mirror arrays, laser diode arrays, light emitting diode arrays, grating light valves, and/or LCD arrays. A patterning device whose pattern is programmable with the aid of electronic means (e.g., a computer), such as a patterning device comprising a plurality of programmable elements that can each modulate the intensity of a portion of the radiation beam, (e.g., all the devices mentioned in the previous sentence), including an electronically programmable patterning device having a plurality of programmable elements that impart a pattern to the radiation beam by modulating the phase of a portion of the radiation beam relative to adjacent portions of the radiation beam, is referred to herein as a “contrast device”. In an embodiment, such a patterning device comprises at least 10 programmable elements, e.g. at least 100, at least 1000, at least 10000, at least 100000, at least 1000000, or at least 10000000 programmable elements Embodiments of several of these devices are discussed in some more detail below:

A programmable mirror array. This may comprise a matrix-addressable surface having a viscoelastic control layer and a reflective surface. The basic principle behind such an apparatus is that (for example) addressed areas of the reflective surface reflect incident radiation as diffracted radiation, whereas unaddressed areas reflect incident radiation as undiffracted radiation. Using an appropriate spatial filter, the undiffracted radiation can be filtered out of the reflected beam, leaving only the diffracted radiation to reach the substrate; in this manner, the beam becomes patterned according to the addressing pattern of the matrix-addressable surface. It will be appreciated that, as an alternative, the filter may filter out the diffracted radiation, leaving the undiffracted radiation to reach the substrate. An array of diffractive optical MEMS devices may also be used in a corresponding manner. A diffractive optical MEMS device is comprised of a plurality of reflective ribbons that may be deformed relative to one another to form a grating that reflects incident radiation as diffracted radiation. A further alternative embodiment of a programmable mirror array employs a matrix arrangement of tiny mirrors, each of which may be individually tilted about an axis by applying a suitable localized electric field, or by employing piezoelectric actuator. Once again, the mirrors are matrix-addressable, such that addressed mirrors reflect an incoming radiation beam in a different direction to unaddressed mirrors; in this manner, the reflected beam may be patterned according to the addressing pattern of the matrix-addressable mirrors. The required matrix addressing may be performed using suitable electronic means. More information on mirror arrays as here referred to can be gleaned, for example, from U.S. Pat. No. 5,296,891, U.S. Pat. No. 5,523,193, U.S. Pat. No. 7,088,468, and PCT patent application WO 98/33096.

A programmable LCD array. An example of such a construction is given in U.S. Pat. No. 5,229,872.

The lithographic apparatus may comprise one or more patterning devices, e.g. one or more contrast devices. For example, it may have a plurality of arrays of individually controllable elements, each controlled independently of each other. In such an arrangement, some or all of the arrays of individually controllable elements may have one or more common illumination systems (or parts of illumination systems), a common support structure and/or a common projection system (or part of the projection system).

As noted above, the illuminator IL may comprise a programmable mirror array 1, or any other suitable array of individually controllable reflective elements arranged to modulate or change the angular intensity distribution of the illumination beam. The programmable mirror array 1 selectively reflects portions of the illumination beam in different directions in order to change the angular intensity distribution of the illumination beam. That is, the programmable mirror array 1 is arranged to modulate the spatial intensity distribution at the pupil plane of the illumination beam IB.

The programmable mirror array 1 within the illuminator is similar to a programmable mirror array used as a patterning device to impart the pattern to the beam to be projected onto a target portion of the substrate, as described above for the lithographic apparatus of FIG. 1. The skilled person will appreciate that an alternative patterning device known for use within a lithographic apparatus may be suitable for use within the illuminator. However, the number of individually controllable elements (e.g. mirrors) within the illuminator is typically fewer. For instance, the array of individually controllable elements within the illuminator may comprise approximately 60×60 individual elements (e.g. mirrors). Furthermore, each individually controllable element within the illuminator is typically arranged such that it can be tilted in two orthogonal directions, whereas within the patterning device each element typically only tilts in a single direction. Control of the tilt angle for each element (e.g. mirror) maybe achieved by control of one or more charged plates positioned behind each element. Each element is electrostatically attracted to or repelled by the charged plate(s). Alternatively, the control of the tilt angle for each element maybe achieved using a piezoelectric element. Each element is typically of the order of between 0.8 mm×0.8 mm and 3 mm×3 mm, and may be tilted by approximately plus or minus 5° from its center position. The required accuracy for the tilt of an individual element is approximately 1/1000 of the full-scale movement, (or 0.01° for full-scale movement of 10°). Each time the position of an element is altered the settling time is approximately 10 ms.

Being able to modulate the illumination beam that is incident upon the array of individually controllable elements may be desirable for one or more embodiments of a lithographic apparatus in which it is desirable to be able to rapidly switch between different cross sections of an illumination beam. Additionally or alternatively, such a controllable array may be useful in that it is relatively cheap and flexible in providing any desired illumination setting. For instance, for a particular lithographic apparatus, it may be necessary to switch between different lithographic patterning devices in order to project different patterns onto a target area of the substrate. Each patterning device may itself require an illumination beam with a different mode (i.e. angular intensity distribution). As noted above, a lithographic apparatus may provide varying modes (i.e. varying angular intensity distributions) for the illumination beam by providing a diffractive optical element in the illuminator that can be changed between exposures of the substrate. However, it can be time consuming to change the illuminator mask, for instance when the patterning device is switched. Therefore the ability to rapidly and controllably change the cross section of the illumination beam by controlling an array of individually controllable elements may be advantageous.

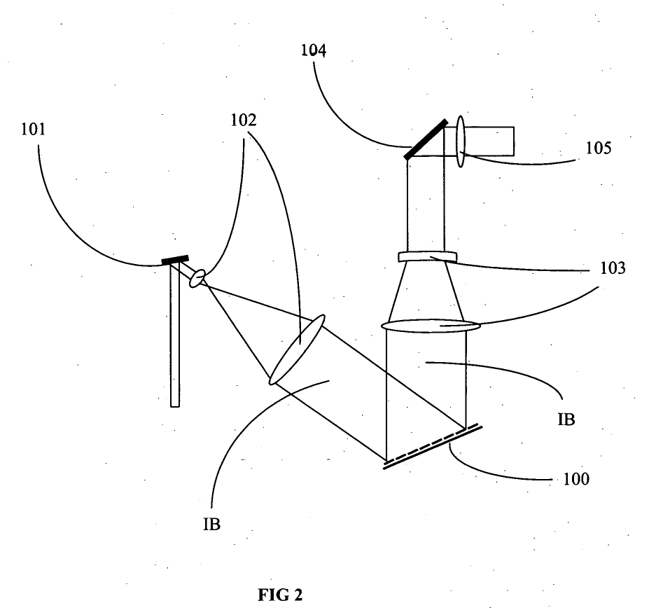

FIG. 2 depicts a part of an illuminator. The part illustrated is used to shape and change the angular intensity distribution of the propagating illumination beam IB. The angular intensity distribution of the illumination beam IB is controlled using a flat programmable mirror array 100. Before the angular intensity distribution of the illumination beam IB is changed, the illumination beam IB is passed through a homogenizer to ensure that the illumination beam IB has a uniform intensity profile across its cross-section. The illumination beam IB is then reflected towards the programmable mirror array 100 by a first mirror 101. Located between the first mirror 101 and the programmable mirror array 100 are a plurality of lenses 102, which are used to expand the width (e.g., diameter) of the illumination beam IB, and also to collimate the beam. In order to make the most efficient use of the programmable mirror array 100, the illumination beam IB is expanded so that its incident upon the entire surface (or of the majority of the entire surface) of the programmable mirror array 100.

After the illumination beam IB has been expanded, its angular intensity distribution is then controlled by the programmable mirror array 100 by selectively reflecting parts of the illumination beam IB in different directions. This is achieved by tilting individual mirrors within the programmable mirror array 100. The programmable mirror array 100 thus changes the spatial intensity distribution at the pupil plane of the illumination beam IB. The illumination beam IB is reflected towards another plurality of lenses 103 which are used to reduce the size of the beam to a desired extent. The illumination beam IB is then reflected off a second mirror 104 which may be used to direct the illumination beam IB to other lenses 105 or other equipment which may be used to further condition the illumination beam IB. In this Figure, the mirror array 100 is larger than the pupil plane, but it will be understood that this is not essential.

In order to make the most efficient use of the programmable mirror array 100, the illumination beam IB is expanded, which requires the use of a plurality of lenses 102. Once the angular intensity distribution of the illumination beam IB has been controlled, lenses 103 are required to reduce the beam width (e.g., diameter) to the required extent. The lenses 102, 103 required to expand and then reduce the beam width take up a lot of space. The implication of this is that an illuminator using a flat programmable mirror array 100 to modulate the illumination beam IB has a larger footprint (i.e. is bigger) than an illuminator that does not use a flat programmable mirror array to modulate the illumination beam IB. An illuminator using a flat array of individually controlled elements may be up to 500 millimetres greater in size than an illuminator that does not use a flat array of individually controlled elements. Of course, the same is true of an illuminator provided with any suitable array of individually controllable reflective elements. Since space within and around a typical lithographic apparatus is valuable, an increase in size in the illuminator may have a corresponding increase in terms of cost. It is therefore desirable to keep the illuminator as small as possible.

The programmable mirror array 100 of FIG. 2 is flat. Because the programmable mirror array 100 is flat, the illumination beam IB which is incident upon its surface needs to be collimated (or at least substantially collimated), hence the need for the lenses 102. The inclusion of the lenses 102 increases the footprint of the illuminator. However, a programmable mirror array, or any suitable array of individually controllable reflective elements, does not need to be flat (or, at least, the default orientation of elements within the array does not need to be flat).

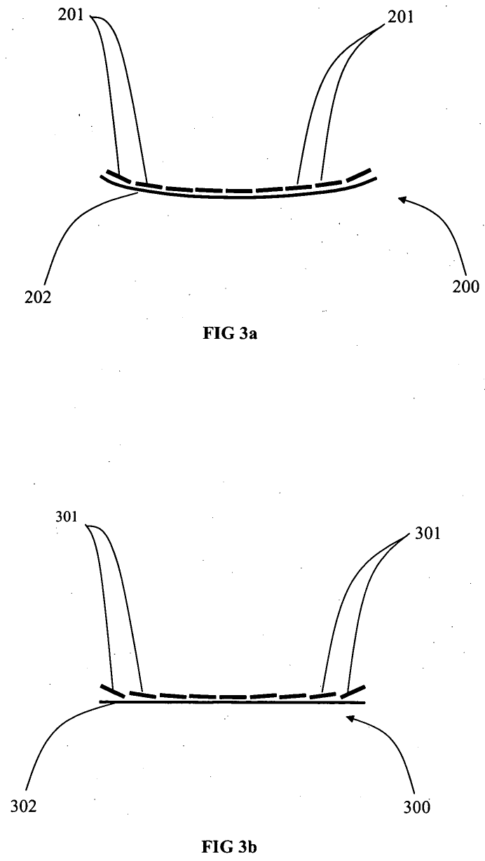

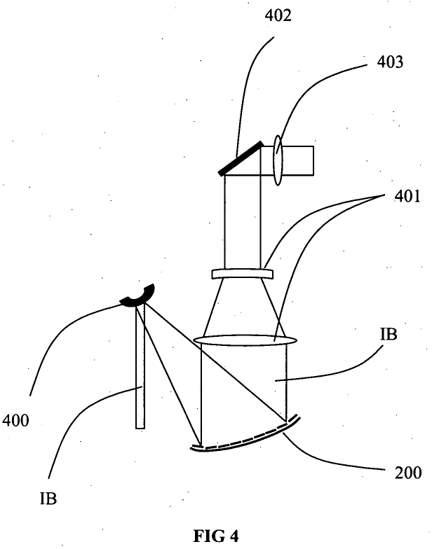

FIGS. 3a and 3b illustrate side views of programmable mirror arrays according to an embodiment of the invention. FIG. 3a depicts a curved programmable mirror array 200. The programmable mirror array 200 comprises an array of mirror elements 201 which are attached to a curved supporting structure 202, for example a substrate or the like. In an identical manner to the programmable mirror array 100 described in relation to FIG. 2, the curved programmable mirror array 200 of FIG. 3a is able to control the angular intensity distribution of an illumination beam IB. In other words, mirror elements 201 of the curved programmable mirror array 200 can be angled to selectively reflect portions of the illumination IB in different directions to change the spatial intensity distribution at a pupil plane of the illumination beam IB. However, the curved programmable mirror array 200 of FIG. 3a is different from the flat programmable mirror array 100 of FIG. 2 in that the curved programmable mirror array 200 functions as a sort of reflective lens, which can collimate an incident beam of diverging radiation. The fact that the curved programmable mirror array 200 may be used as a reflective lens is a possible advantage of the illuminator, as will be described in relation to FIG. 4. An array control apparatus may provide elements 201 of the array 200 with different signals to vary the angles at which they lie to the support structure 200, in order to selectively reflect parts of an incident illumination beam in different directions. The array control apparatus may be a computer, or any other suitable apparatus. The array control apparatus may be part of the illuminator, or connected to the illuminator and thereby may form a part of the illumination system.

Referring now to FIG. 3b, another programmable mirror array 300 is illustrated. The programmable mirror array 300 comprises an array of individual mirror elements 301, each of which is mounted on a support structure 302, for example a substrate or the like. However, in contrast to the curved support structure 202 of the curved programmable mirror array 200 of FIG. 3a, the support structure 302 of the mirror array 300 of FIG. 3b is flat. Instead of the mirror elements 301 being mounted on a curved supporting structure, the mirror elements 301 are angled at specific angles to obtain the same effect as if the mirror elements 301 were indeed mounted on a curved support structure. The mirror elements 301 are angled such that the mirror array 300 reflects radiation in the same way as if it were a curved surface—i.e. the mirror elements 301 are angled such that the mirror array 300 acts as concave Fresnel mirror (or reflector). A given beam of radiation incident upon the mirror array of FIG. 3b will therefore, in general, be subjected to the same conditioning as a beam of radiation incident upon the mirror array of FIG. 3a. The angles of the elements necessary to achieve the Fresnel mirror effect can be calculated using experimentation, trial and error, computer modelling, manual calculations, by ray-tracing or any other suitable method. An array control apparatus may supply the mirror elements 301 of the mirror array 300 with a composite signal, the composite signal comprising an offset value, which serves to set the array, by default, to behave as a Fresnel mirror, and a second control signal, which serves to control the angles of the mirror elements 301 relative to the position defined by the set (i.e. Fresnel) value. The mirror elements 301 could alternatively be provided with a signal which, by default, causes the mirror elements 301 to align in such a way that causes the array 300 as a whole to behave like a Fresnel mirror. That signal could be varied to cause each mirror element 301 to tilt to a desired angle relative to the default (i.e. Fresnel) angle. Alternatively, two signals could, be applied to the mirror elements 301, an offset signal to determine the default (i.e. Fresnel) angle of the mirror element 301, and another variable control signal to control the angle of the mirror elements 301 relative to the default (i.e. Fresnel) angle. The signals applied to the mirror elements can be DC voltages. The signals required to configure the array 300 to serve as Fresnel mirror can be considered as DC offsets to these voltages. In general, a signal is sent to the array 300 to control the position of the mirror elements 301, taking into account an offset signal or value arranged to cause the elements 301 to serve as a Fresnel mirror. More than one signal may be provided to the array 300, for example one for each element. Alternatively, the array may be provided with one or more composite signals which are arranged to address one or more elements 301 of the array 300.

The use of a Fresnel mirror generally reduces the quality of a reflected image in comparison to a continuous lens which the Fresnel lens has been constructed to behave like. The quality of the image is reduced due to the irregular nature of the surface of the Fresnel mirror. Boundaries between parts of the surface of the Fresnel mirror are not able to reflect radiation in a desired direction, thus reducing the quality of the reflected image. When a mirror array is used to condition the illumination beam, the array will have areas between the mirrors which cannot reflect radiation. This means that when the array is used as Fresnel mirror (and therefore has areas which cannot reflect radiation in a desired direction), the reduction in quality of a reflected image is less pronounced, since the continuous (or flat) array already had areas which could not reflect radiation.

It can be seen from FIGS. 3a and 3b that, in a default position, the majority of elements within each of the arrays are angled toward the center of the array, so that the array functions as a reflective lens. In the absence of a signal from the control apparatus, the mirror array 200 of FIG. 3a is able to collimate (or substantially collimate) a divergent incident illumination beam. With regard to the mirror array 300 of FIG. 3b, if the mirror elements 301 are only provided with a default (i.e. Fresnel) signal, the mirror array 300 is able to collimate (or substantially collimate) a divergent incident illumination beam.

FIG. 3a shows the curved mirror array 200 as being curved in one-dimension (e.g. it is as an elongate U-shape, or the like). It will be appreciated that the curved mirror array may be curved in two-dimensions (e.g. such that the array is bowl shaped, or the like), in which case the mirrors 201 will be angled towards the center of the array. Curvature of the curved mirror array 200 in one-dimension only may be sufficient if the illumination beam IB incident upon the curved mirror array 200 is non-symmetric, and/or if divergence of the illumination beam IB only needs to be compensated for in one-dimension. In this case, the mirror elements 201 of the mirror array 200 may be directed towards another center of the array 200, specifically the center (or mid-point) of the arc which defines the curvature of the array 200. This center will extend as an imaginary line along and across the array 200 (e.g. along the bottom of the elongate U-shaped array). One dimensional curvature of the mirror array 200 may desirable if the illumination beam IB incident upon it is rectangular in cross section. Similarly, if the mirror array 300 of FIG. 3b is used, the mirrors 301 may be angled such that the mirror array 300 acts as a Fresnel mirror in one or two dimensions. The mirrors 301 can be angled to have the same effect as the curved mirror array 200 of FIG. 3a, i.e. the mirrors can be angled towards the center of the array 300, or towards an imaginary center line extending across the array 300.

FIG. 4 illustrates a part of an illuminator IL of the lithographic apparatus of FIG. 1 in which a curved mirror array 200 is provided (i.e. the curved mirror array 200 of FIG. 3a). It will be appreciated that a mirror array having mirrors tilted at specific angles such that the mirror array serves, by default, as a Fresnel mirror (e.g. the mirror array of FIG. 3b) could be used in place of the curved mirror array 200. FIG. 4 shows a homogenized illumination beam IB being directed towards a convex mirror 400. The convex mirror 400 reflects the illumination beam 1IB towards the curved mirror array 200, the convex surface of the convex mirror 400 causing the illumination beam IB to diverge as it travels towards the curved mirror array 200. It will be appreciated that any suitably curved reflective surface can be used to cause the illumination beam IB to diverge and be directed toward the mirror array 200. The curvature of the convex mirror 400 and/or the space in-between the convex mirror 400 and the curved mirror array 200 is chosen such that the diverging illumination beam IB is incident upon most or all of the surface of the mirror array 200. As described above, the mirror elements of the mirror array 200 are moved to control the angular intensity distribution of the illumination.

In contrast to the flat mirror array 100 of FIG. 2, the curved mirror array 200 of FIG. 4 functions as a reflective lens, and is able to compensate for divergence of the incident illumination beam IB. In other words, upon reflection from the curved mirror array 200, the illumination beam IB as a whole is neither diverging nor converging—it is substantially parallel to the optical axis of the curved mirror array 200. It will, however, be appreciated that the reflected beam as a whole may not be collimated, since the mirror elements of the curved array 200 may be angled to direct parts of the incident illumination beam in different directions, in order to obtain a desired angular intensity distribution in the propagating illumination beam IB. The reflected illumination beam IB will be collimated if the mirror elements are not angled to change the angular distribution of the illumination beam. This can be considered a default position, when no signal controlling the angles of the mirror elements is sent to the array (by, for example, the array control apparatus, which is not shown). Once the illumination beam IB is reflected from the curved mirror array 200, it is passed through a plurality of lenses 401 which are provided to reduce the width of the illumination beam IB to a desired extent. Once it has passed through the lenses 401, the illumination beam IB is incident upon a mirror 402 which may be used to direct the illumination beam IB to a desired target, for example further lenses 403 or other equipment. It will be appreciated that when, for example, the illumination beam IB is focused by a lens, the angular intensity distribution in the propagating illumination beam IB is transformed into a spatial intensity distribution in the cross section of the illumination beam IB (in accordance with Fourier transform theory). In this Figure the curved mirror array 200 is larger than the pupil plane, but it will be understood that this is not essential.

From a comparison of FIGS. 2 and 4, it can be seen that by using a curved mirror array (or a mirror array configured as a curved reflective surface, such as a Fresnel mirror) the number of components required to change the angular distribution of the illumination beam IB is reduced. Specifically, because the curved mirror array 200 of FIG. 4 functions as a reflective lens and is able to compensate for the divergence of an incident diverging illumination beam IB, it is not necessary to provide the plurality of lenses 102 of FIG. 2 which are used to collimate the illumination beam and expand it to the desired extent. Since these lenses 102 are not required if a curved mirror array is used, the size of the illuminator may be reduced, since less components have to be housed within the illuminator.

As described previously, space within and around a lithographic apparatus is valuable, and so a reduction in the size of the illuminator by using a curved mirror array may reduce cost as well as saving space. Additionally, lenses used in lithography are often expensive due to the strict requirements often associated with lithography. For example, lenses often need to be extremely smooth, have a very low birefringence and have a very low thermal expansion coefficient. If these expensive lenses are not required due to the incorporation of a curved mirror array, the cost of the lithographic apparatus, or the illuminator of the lithographic apparatus, may be further reduced. Furthermore, lenses may be heavy, so the less lenses that are required, the lighter the illuminator and/or lithographic apparatus is. This may reduce transport costs, etc. It is also well known that the intensity of a radiation beam reduces each time it passes through a lens. By using a curved mirror array (or a mirror array configured as a Fresnel mirror), less lenses may be required, and so the reduction in intensity of the radiation beam may be less than in a prior art illuminator.

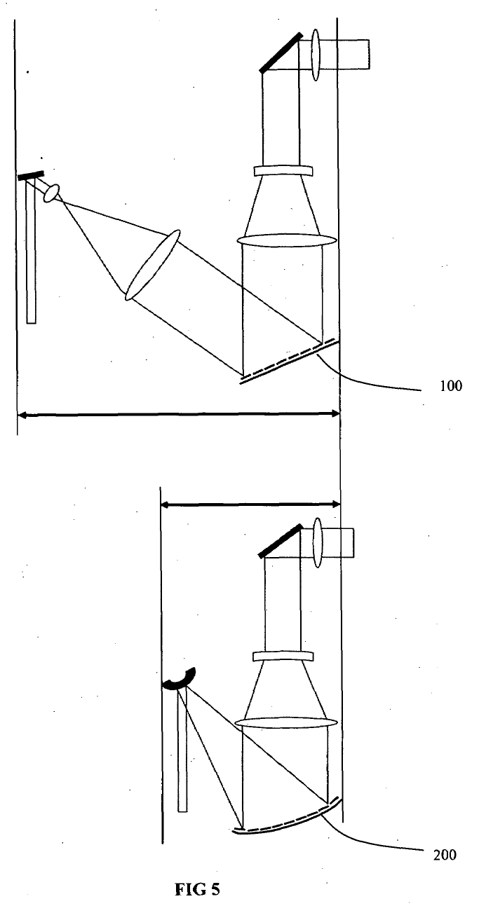

FIG. 5 illustrates a comparison between the illuminator parts illustrated in FIGS. 2 and 4. It can be seen that the footprint of the illuminator which incorporates the curved mirror array 200 is much smaller than the illuminator which is provided with a flat mirror array 100.

As described above, a programmable mirror array is not essential. For example, any suitable array of individually controllable reflective elements may be used. The elements of the array may be provided on a curved supporting surface. Alternatively, elements of the array may be arranged so that the array of reflective elements serves as a curved reflective surface, such as a Fresnel mirror. The curved array or array arranged to serve as a curved reflective surface may be, for example, spherical or aspherical. The curvature of the array may be concave or convex, and the curvature may depend on whether the beam incident on the array is diverging or converging.

It may be easier and less expensive to manufacture an array of individually controllable reflective elements which are provided on a flat supporting structure, and which are angled toward the center of the array to behave as a Fresnel mirror. Elements within the array may be constructed so that they, by default, lie at an angle to the supporting structure (i.e. the elements may be provided on the array at the correct angles). Alternatively or additionally, elements within the array may, by default, lie parallel to the supporting structure, and the Fresnel mirror effect may be introduced by manipulating the angles at which different elements within the array lie to the supporting structure (for example by establishing electrostatic fields between the elements and the supporting structure using signals provided by an array control apparatus).

The array of individually controllable reflective elements may be used to correct for imperfections in optical apparatus used in the illuminator. For example, the position or orientation of elements of the array may be controlled to correct for imperfections in one or more of the lenses used in the illuminator. Correcting for the imperfections of a lens may result in that lens not being required, further reducing the cost, size and/or complexity of the illuminator. For example, the position or orientation of elements of the array may be controlled such that the array serves as an aspherical reflective surface, which may be useful for optimizing the optical properties of the illuminator.

Referring back to FIG. 4, typical (although non-restrictive) beam sizes and magnifications are now described. A diameter of the radiation beam which is incident upon the convex mirror 400 is typically 20-50 mm. Reflection from the convex mirror 400 causes the illumination beam IB to diverge, and be magnified by a factor of 5-10 times, before it is incident on the curved mirror array 200. A diameter of the illumination beam IB reflected from the curved mirror array 200 is typically around 270 mm. It will be appreciated however that these values may vary depending upon the input parameters of the illumination beam IB, the apparatus used to condition the illumination beam IB and also on the desired properties (for example, diameter) of the illumination beam IB provided by the illuminator. For example, a diameter of the illumination beam IB reflected from the curved mirror array 200 may be around 270 mm for an array having mirrors of a pitch of 3 mm, but only around 70 mm for mirrors having a pitch of 1 mm. It will also be appreciated that these typical values apply to the use of the mirror array 300 of FIG. 3b.

It will be appreciated by one skilled in the art that the above embodiments have been described by way of example only. It will be appreciated that various modifications may be made to these and indeed other embodiments without departing from the scope of the invention, as defined by the claims that follow.

1. An illuminator for a lithographic apparatus, the illuminator comprising:
an array of individually controllable reflective elements capable of changing the angular intensity distribution of an incident illumination beam of radiation,
wherein the array of individually controllable reflective elements is provided on a curved support structure, or the array of individually controllable reflective elements is arranged to serve as a curved reflective surface.

2. The illuminator of claim 1, wherein the array of individually controllable reflective elements is on a concave side of the curved support structure.

3. The illuminator of claim 1, wherein the array of individually controllable reflective elements is on the curved support structure, and the support structure is curved in one dimension.

4. The illuminator of claim 1, wherein the array of individually controllable reflective elements is on the curved support structure, and the support structure is curved in two dimensions.

5. The illuminator of claim 1, wherein the array of individually controllable reflective elements is on the curved support structure, and each element of the array of individually controllable reflective elements lies substantially parallel to the curved support structure.

6. The illuminator of claim 1, wherein the array of individually controllable reflective elements is on the curved support structure, and the array is arranged to receive an input signal from an array control apparatus, the input signal being configured to control the orientation or position of the reflective elements of the array.

7. The illuminator of claim 6, wherein, in the absence of an input signal, the array of individually controllable reflective elements substantially collimates the incident illumination beam of radiation.

8. The illuminator of claim 1, wherein the array of individually controllable reflective elements is on a convex side of the curved support structure.

9. The illuminator of claim 1, wherein the array of individually controllable reflective elements is on a spherical or an aspherical support structure.

10. The illuminator of claim 1, wherein the array of individually controllable reflective elements is arranged to serve as the curved reflective surface, and the array is arranged to receive an input signal from an array control apparatus, the input signal being configured to control the orientation or position of the reflective elements of the array.

11. The illuminator of claim 10, wherein the array control apparatus is arranged to provide an input signal which is calculated taking into account an offset input signal, the offset input signal being arranged, when received by the array in the absence of any other input signal, to cause the elements of the array to be arranged to serve as the curved reflective surface.

12. The illuminator of claim 11, wherein, in the absence of an input signal other than the offset input signal, the array of individually controllable reflective elements are arranged to substantially collimate the incident illumination beam of radiation.

13. The illuminator of claim 11, wherein the input signal comprises the offset input signal.

14. The illuminator of claim 11, wherein the input signal comprises a superposition of the offset input signal and a control input signal, the array of individually controllable reflective elements being moveable from the default position in response to receipt of the control input signal.

15. The illuminator of claim 1, wherein the array of individually controllable reflective elements is arranged to serve as the curved reflective surface, and the elements are arranged to serve as a Fresnel mirror.

16. The illuminator of claim 1, wherein the array of individually controllable reflective elements is arranged to serve as the curved reflective surface, and the curved reflective surface is concave.

17. The illuminator of claim 1, wherein the array of individually controllable reflective elements is arranged to serve as the curved reflective surface, and the curved reflective surface is convex.

18. The illuminator of claim 1, wherein the array of individually controllable reflective elements is arranged to serve as the curved reflective surface, and the reflective elements are moveable to positions or orientations to cause the array of individually controllable reflective elements to serve as the curved reflective surface.

19. The illuminator of claim 1, wherein the array of individually controllable reflective elements is arranged to serve as the curved reflective surface, and the reflective elements are provided in positions or orientations which cause the array of individually controllable reflective elements to serve as the curved reflective surface.

20. The illuminator of claim 1, wherein the array of individually controllable reflective elements is arranged to serve as a curved reflective surface in one dimension.

21. The illuminator of claim 1, wherein the array of individually controllable reflective elements is arranged to serve as a curved reflective surface in two dimensions.

22. The illuminator of claim 1, wherein the array of individually controllable reflective elements is arranged to serve as a spherical or an aspherical reflective surface.

23. The illuminator of claim 1, further comprising a convex reflective surface configured to reflect the illumination beam onto the array of individually controllable reflective elements.

24. The illuminator of claim 1, wherein the reflective elements of the array of individually controllable reflective elements are provided with a flat reflective surface.

25. The illuminator of claim 1, wherein the reflective elements of the array of individually controllable reflective elements are mirrors.

26. The illuminator of claim 1, wherein the array of individually controllable reflective elements is a programmable mirror array.

27. The illuminator of claim 1, wherein the reflective elements of the array of individually controllable reflective elements are coated with a reflective coating.

28. A method of conditioning an illumination beam of radiation using an illuminator, the method comprising:
illuminating an array of individually controllable reflective elements with the illumination beam of radiation, the array of individually controllable reflective elements being capable of changing the angular intensity distribution of the illumination beam of radiation; and
controlling the position or orientation of the reflective elements by providing the array of individually controllable reflective elements with an input signal to cause the array to serve as a curved reflective surface.

29. The method of claim 28, wherein the input signal is calculated taking into account an offset input signal, the offset input signal being arranged to, when received by the array in the absence of any other input signal, cause the elements of the array to move to a default position where the array of individually controllable reflective elements serves as the curved reflective surface.

30. The method of claim 29, wherein, in the absence of an input signal other than the offset input signal, the array of individually controllable reflective elements are arranged to substantially collimate the illumination beam of radiation.

31. The method of claim 29, wherein the input signal comprises the offset input signal.

32. The method of claim 29, wherein the input signal comprises a superposition of the offset input signal and a control input signal, the array of individually controllable reflective elements being moveable from the default position in response to receipt of the control input signal.

33. The method of claim 29, wherein, in response to the offset input signal from the array control apparatus, the elements of the array of individually controllable reflective elements are moveable to a configuration where the array serves as a Fresnel mirror.

34. The method of claim 29, wherein, in response to the offset input signal from the array control apparatus, the elements of the array of individually controllable reflective elements are moveable to a configuration where the array serves as a concave reflective surface.

35. The method of claim 29, wherein, in response to the offset input signal from the array control apparatus, the elements of the array of individually controllable reflective elements are moveable to a configuration where the array serves as a convex reflective surface.

36. The method of claim 29, wherein, in response to the offset input signal from the array control apparatus, the elements of the array of individually controllable reflective elements are moveable to a configuration where the array serves as a spherical or an aspherical reflective surface.

37. The method of claim 29, wherein the elements of the array of individually controllable reflective elements are provided with a flat reflective surface.

38. The method of claim 29, wherein the elements of the array of individually controllable reflective elements are mirrors.

39. The method of claim 29, wherein the array of individually controllable reflective elements is a programmable mirror array.

40. A method of correcting for imperfections in an optical apparatus used in an illuminator, the illuminator comprising an array of individually controllable reflective elements capable of changing the angular intensity distribution of an incident illumination beam of radiation, the array of individually controllable reflective elements being provided on a curved support structure, or the array of individually controllable reflective elements being arranged to serve as a curved reflective surface, the method comprising:
illuminating the array of individually controllable reflective elements with the illumination beam of radiation; and
controlling the position or orientation of the reflective elements to correct for imperfections in the optical apparatus used in the illuminator.

41. The method of claim 40, wherein the optical apparatus comprises a lens, and the position or orientation of the reflective elements being controlled to correct for imperfections in the lens.

42. A lithographic apparatus, comprising:
an illuminator configured to condition a beam of radiation, the illuminator comprising an array of individually controllable reflective elements capable of changing the angular intensity distribution of an incident illumination beam of radiation, the array of individually controllable reflective elements being provided on a curved support structure, or the array of individually controllable reflective elements being arranged to serve as a curved reflective surface;
a support structure configured to hold a patterning device, the patterning device configured to impart the beam with a pattern in its cross-section;
a substrate table configured to hold a substrate; and
a projection system configured to project the patterned beam onto a target portion of the substrate.
